(19) United States
(12) Patent Application Publication
(10) Pub. No.: US 2016/0121817 A1
(43) Pub. Date: May 5, 2016

(54) METHOD AND SYSTEM FOR CONTROLLING VEHICLE

(71) Applicant: LAUNCH TECH COMPANY LIMITED, Shenzhen, Guangdong (CN)

(72) Inventors: Jun LIU, Shenzhen, Guangdong (CN); Zhi LIU, Shenzhen, Guangdong (CN)

(73) Assignee: LAUNCH TECH COMPANY LIMITED, Shenzhen, Guangdong (CN)

(21) Appl. No.: 14/893,195

(22) PCT Filed: Jan. 14, 2014
(86) PCT No.: PCT/CN2014/070602

§ 371 Date: Nov. 23, 2015

(30) Foreign Application Priority Data
Jul. 4, 2013 (CN) 201310279956.5

(51) Int. Cl. B60R 16/023; B60N 2/02; E05F 15/77; B60H 1/00

(52) U.S. Cl. CPC B60R 16/023; B60H 1/00657; B60N 2/0224; E05F 15/77

(57) ABSTRACT

A method and system for controlling a vehicle. The method comprises: a mobile terminal (301) receives a vehicle control instruction (101) issued by a user, the mobile terminal (301) transmits a first control instruction to a diagnostic card (302) on the basis of the vehicle control instruction to request for control of the vehicle (102), the diagnostic card (302) parses the received first control instruction to acquire a parsing result (103), and the diagnostic card (302) controls the vehicle according to the parsing result (104). This allows a backseat passenger to control the vehicle via the mobile terminal (301), while at the same time prevents a driver from having to divert attention to helping the backseat passenger in making an adjustment, thus facilitating the backseat passenger in controlling the vehicle.

### CROSS REFERENCE OF RELATED APPLICATION

The present application claims the priority to Chinese Patent Application No. 201310279956.5, titled “METHOD AND SYSTEM FOR CONTROLLING VEHICLE”, filed with the Chinese State Intellectual Property Office on Jul. 4, 2013, the entire disclosure of which is incorporated herein by reference.

### FIELD

The present disclosure relates to the field of communication, and in particular to a method and system for controlling a vehicle.

### BACKGROUND

With continuous improvement of the living standard, cars become more and more popular. Although facilities in a vehicle, such as seats, windows or an air conditioner, have been improved towards intelligence, manual operations are still necessary and result in inconvenience to passengers. For example, in a case that a passenger in a rear seat of the vehicle needs to adjust facilities such as a window or a seat in a front row, this passenger usually needs to request a front passenger or a driver for help. It results in a lot of inconvenience in controlling the vehicle to the passenger in the rear seat.

### SUMMARY

A method and system for controlling a vehicle are provided according to the present disclosure, to facilitate a passenger in a rear seat to control the vehicle.

The method for controlling a vehicle according to an embodiment of the present disclosure includes: receiving, by a mobile terminal, a vehicle control instruction sent by a user; transmitting, by the mobile terminal in response to the vehicle control instruction, a first control instruction to a diagnostic card to request for controlling the vehicle; parsing, by the diagnostic card, the received first control instruction to obtain a parsing result; and controlling, by the diagnostic card, the vehicle according to the parsing result.

The system for controlling a vehicle according to an embodiment of the present disclosure includes: a mobile terminal, and a diagnostic card connected to the vehicle; where the mobile terminal is configured to receive a vehicle control instruction sent by a user, and transmit, in response to the vehicle control instruction, a first control instruction to the diagnostic card to request for controlling the vehicle; and the diagnostic card is configured to parse the received first control instruction to obtain a parsing result and control the vehicle according to the parsing result.

According to the above technical solutions, the embodiments of the present disclosure have the following advantages:

in the embodiments of the present disclosure, the mobile terminal receives a vehicle control instruction sent by a user and transmits a first control instruction to a diagnostic card in response to the vehicle control instruction to request for controlling the vehicle; the diagnostic card parses the received first control instruction to obtain a parsing result and controls the vehicle according to the parsing result, such that a passenger in a rear seat can control the vehicle by using the mobile terminal, and it is prevented that a driver is distracted to help the passenger in the rear seat in making an adjustment, thereby facilitating the passenger in the rear seat to control the vehicle.

### BRIEF DESCRIPTION OF THE DRAWINGS

FIG. 1 is a schematic view of a method for controlling a vehicle according to an embodiment of the present disclosure;

FIG. 2 is a schematic view of a method for controlling a vehicle according to another embodiment of the present disclosure;

FIG. 3 is a schematic view of a system for controlling a vehicle according to an embodiment of the present disclosure; and

FIG. 4 is a schematic structural view of a mobile terminal according to an embodiment of the present disclosure.

### DETAILED DESCRIPTION OF THE EMBODIMENTS

A method and system for controlling a vehicle are provided according to embodiments of the present disclosure, to facilitate a passenger in a rear seat to control the vehicle.

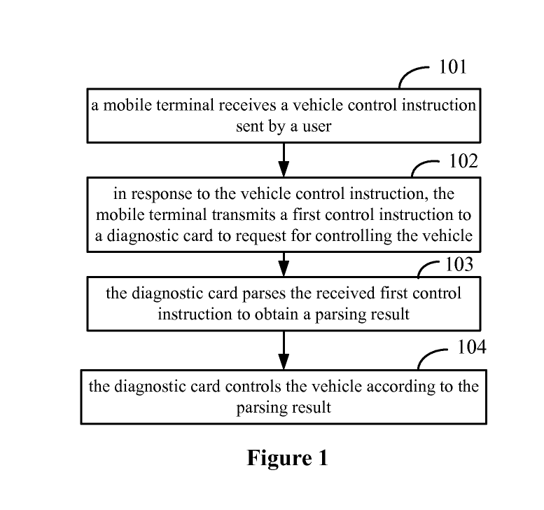

Referring to FIG. 1, the method for controlling a vehicle according to an embodiment of the present disclosure includes steps 101 to 104.

In step 101, a mobile terminal receives a vehicle control instruction sent by a user.

In the embodiment, firstly, the user sends a vehicle control instruction such as a gesture or a voice, which is not limited here. Then the mobile terminal receives the vehicle control instruction sent by the user. In addition, a client for controlling the vehicle may be provided in the mobile terminal for operations performed by the user.

In step 102, in response to the vehicle control instruction, the mobile terminal transmits a first control instruction to a diagnostic card to request for controlling the vehicle.

In the embodiment, after the vehicle control instruction is received in step 101, in response to the vehicle control instruction sent by the user, the mobile terminal transmits the first control instruction to the diagnostic card to request for controlling the vehicle.

In step 103, the diagnostic card parses the received first control instruction to obtain a parsing result.

In step 104, the diagnostic card controls the vehicle according to the parsing result.

In the embodiment, firstly, the diagnostic card parses the first control instruction, and then controls the vehicle according to the parsing result. The diagnostic card may be connected to the vehicle by using wired communication. For example, the diagnostic card is connected to an electronic control system of the vehicle, and controls the electronic control system of the vehicle by using the wired communication. The diagnostic card may also be connected to the vehicle by using wireless communication, for example using a wireless communication mode such as Wireless fidelity WIFI or Bluetooth, and control the electronic control system of the vehicle by using the wireless communication.

In the embodiment, the mobile terminal receives the vehicle control instruction sent by the user, the mobile terminal transmits the first control instruction to the diagnostic card to request for controlling the vehicle; the diagnostic card parses the first control instruction and controls the vehicle according to a parsing result of the first control instruction, such that a passenger in a rear seat can control the vehicle by using the mobile terminal, and it is prevented that a driver is distracted to help the passenger in the rear seat in making an adjustment, thereby facilitating the passenger in the rear seat to control the vehicle.

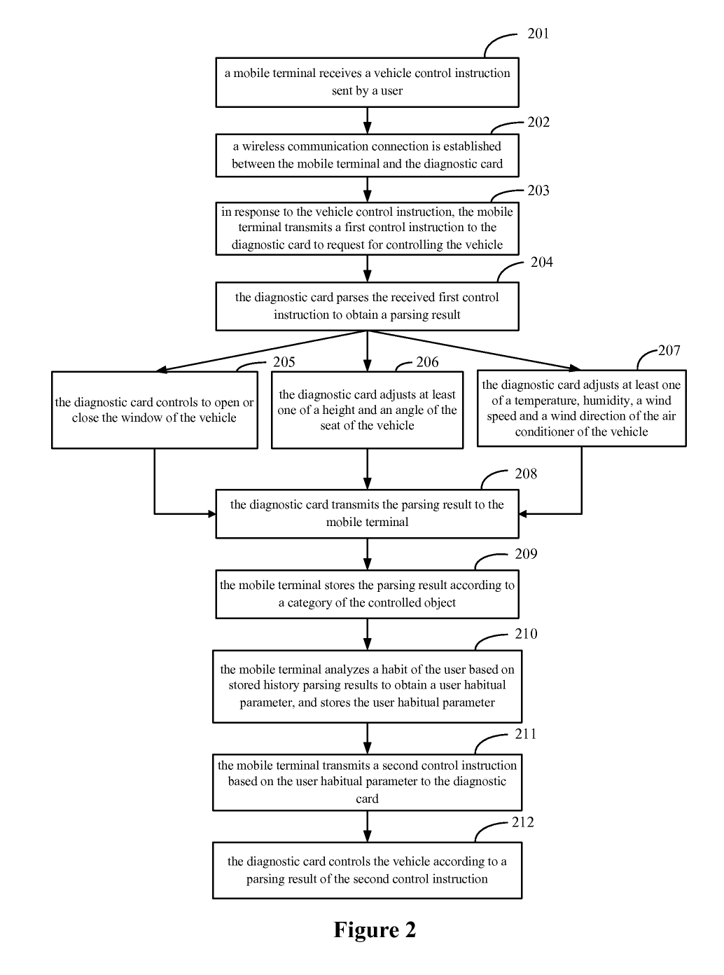

To facilitate understanding, the method for controlling the vehicle according to the embodiment of the present disclosure is described by an example hereinafter. Referring to FIG. 2, a method for controlling a vehicle according to an embodiment of the present disclosure includes steps 201 to 212.

In step 201, a mobile terminal receives a vehicle control instruction sent by a user.

In the embodiment, firstly, the user sends a vehicle control instruction such as a gesture or a voice, which is not limited here. Then the mobile terminal receives the vehicle control instruction sent by the user. In addition, a client for controlling the vehicle may be provided in the mobile terminal for operations performed by the user.

In step 202, a wireless communication connection is established between the mobile terminal and the diagnostic card.

In the embodiment, a Bluetooth connection, a WIFI connection, a near field communication NFC connection or an infrared connection may be established between the mobile terminal and the diagnostic card. Practically, those skilled in the art may also establish the wireless communication connection by using other wireless communication modes, which are not limited here. Correspondingly, the diagnostic card includes one or a combination of functions of Bluetooth, WIFI, NFC, infrared and other wireless communication modes.

In step 203, in response to the vehicle control instruction, the mobile terminal transmits a first control instruction to the diagnostic card to request for controlling the vehicle.

In the embodiment, after the mobile terminal establishes the wireless communication connection with the diagnostic card in step 202, in response to the vehicle control instruction, the mobile terminal may transmit the first control instruction to the diagnostic card and use wireless communication to request for controlling the vehicle. The first control instruction may indicate controlling an air conditioner of the vehicle, may indicate controlling a window, or may indicate controlling other facilities of the vehicle for example an audio system, which is not limited here.

In step 204, the diagnostic card parses the received first control instruction to obtain a parsing result.

In the embodiment, the parsing result may indicate controlling the window, may indicate controlling a seat of the vehicle, may indicate control the air conditioner, or may indicate controlling other facilities of the vehicle, which is not limited here.

In step 205, the diagnostic card controls to open or close the window of the vehicle.

In step 206, the diagnostic card adjusts at least one of a height and an angle of the seat of the vehicle.

In step 207, the diagnostic card adjusts at least one of a temperature, humidity, a wind speed and a wind direction of the air conditioner of the vehicle.

In the embodiment, the diagnostic card controls to open or close the window according to the parsing result, in a case that the parsing result indicates controlling the window in step 204; the diagnostic card adjusts at least one of the height and the angle of the seat of the vehicle according to the parsing result, in a case that the parsing result indicates controlling the seat in step 204; or the diagnostic card adjusts at least one of the temperature, the humidity, the wind speed and the wind direction of the air conditioner of the vehicle according to the parsing result, in a case that the parsing result indicates controlling the air conditioner in step 204.

It should be noted that, the diagnostic card may be connected to the vehicle by using wired communication. For example, the diagnostic card is connected to an electronic control system of the vehicle, and controls the electronic control system of the vehicle by using the wired communication. The diagnostic card may also be connected to the vehicle by using wireless communication, for example a wireless communication mode such as WIFI or Bluetooth, and control the electronic control system of the vehicle by using the wireless communication.

In step 208, the diagnostic card transmits the parsing result to the mobile terminal.

In step 209, the mobile terminal stores the parsing result according to a category of the controlled object.

In the embodiment, the diagnostic card transmits the parsing result to the mobile terminal, and then the mobile terminal classifies and stores the parsing result according to the category of the controlled object. For example, a parsing result of the air conditioner is stored in one category, in a case that the controlled object is the air conditioner; or a parsing result of the audio system is stored in another category, in a case that the controlled object is the audio system.

In step 210, the mobile terminal analyzes a habit of the user based on stored history parsing results to obtain a user habitual parameter, and stores the user habitual parameter.

In the embodiment, the mobile terminal may analyze the habit of the user based on the stored history parsing results. Taking the stored history controlled object being the air conditioner as an example. For example, a temperature of the air conditioner is 25 degree Celsius in a parsing result A, a temperature of the air conditioner is 24 degree Celsius in a parsing result B, and a temperature of the air conditioner is 25 degree Celsius in a parsing result C, hence, it is determined by analyzing that the user habitual parameter is the temperature of the air conditioner being 25 degree Celsius, and the user habitual parameter is stored. It is a conventional technique to analyze the habit of the user based on history data, which is not repeated here.

In step 211, the mobile terminal transmits a second control instruction based on the user habitual parameter to the diagnostic card.

In the embodiment, the mobile terminal may transmit the second control instruction to the diagnostic card based on the stored user habitual parameter when the vehicle is started, and the user habitual parameter may be included in the second control instruction.

In step 212, the diagnostic card controls the vehicle according to a parsing result of the second control instruction.

In the embodiment, the diagnostic card parses the second control instruction to obtain a parsing result and controls the vehicle according to the parsing result.

In the embodiment, the mobile terminal receives the vehicle control instruction sent by the user, establishes a wireless communication connection with the diagnostic card, and transmits the first control instruction to the diagnostic card in response to the vehicle control instruction to request for controlling the vehicle. The diagnostic card parses the received first control instruction to obtain the parsing result, and correspondingly controls the vehicle according to the parsing result. The diagnostic card transmits the parsing result to the mobile terminal. The mobile terminal stores the parsing result according to the category of the controlled object, analyzes the habit of the user based on the stored history parsing results to obtain the user habitual parameter, stores the user habitual parameter, and transmits the second control instruction based on the user habitual parameter to the diagnostic card. The diagnostic card controls the vehicle according to the parsing result of the second control instruction, such that a passenger in a rear seat can control the vehicle by using the mobile terminal, and it is prevented that a driver is distracted to help the passenger in the rear seat in making an adjustment, thereby facilitating the passenger in the rear seat to control the vehicle. By analyzing the habit of the user, the mobile terminal controls the vehicle when the vehicle is started, and controls the vehicle automatically based on the habit of the user, thereby improving user experience.

A system for controlling a vehicle according to an embodiment of the present disclosure is described hereinafter, which performs the method for controlling the vehicle described above. A basic logic structure of the system is shown in FIG. 3. The system for controlling the vehicle according to the embodiment of the present disclosure includes:

a mobile terminal 301; and a diagnostic card 302 connected to the vehicle.

The mobile terminal 301 is configured to receive a vehicle control instruction sent by a user, and transmit, in response to the vehicle control instruction, a first control instruction to the diagnostic card 302 to request for controlling the vehicle.

The diagnostic card 302 is configured to parse the received first control instruction to obtain a parsing result, and control the vehicle according to the parsing result.

In the embodiment, the mobile terminal 301 receives the vehicle control instruction sent by the user, and in response to the vehicle control instruction, transmits the first control instruction to the diagnostic card 302 to request for controlling the vehicle; the diagnostic card 302 parses the received first control instruction to obtain a parsing result, and controls the vehicle according to the parsing result, such that a passenger in a rear seat can control the vehicle by using the mobile terminal, and it is prevented that a driver is distracted to help the passenger in the rear seat in making an adjustment, thereby facilitating the passenger in the rear seat to control the vehicle.

In order for better understanding of the embodiments described above, hereinafter data interaction among various terminals included in the system for controlling a vehicle is described. Referring to FIG. 3, an embodiment of the system for controlling a vehicle includes:

a mobile terminal 301; and a diagnostic card 302 connected to the vehicle.

The mobile terminal 301 receives the vehicle control instruction sent by the user, such as a gesture or a voice, which is not limited here. In addition, a client for controlling the vehicle may be provided in the mobile terminal for operations performed by the user.

Then the mobile terminal 301 establishes a communication connection with the diagnostic card 302 by using Bluetooth, WIFI, NFC, or infrared. Practically, those skilled in the art may also establish a wireless communication connection using other wireless communication modes, which are not limited here. Correspondingly, the diagnostic card 302 includes one or a combination of functions of Bluetooth, WIFI, NFC, infrared and other wireless communication modes.

After the mobile terminal 301 establishes the wireless communication connection with the diagnostic card 302, the mobile terminal 301 may transmit the first control instruction to the diagnostic card 302 in response to the vehicle control instruction and using the wireless communication to request for the controlling the vehicle. The first control instruction may indicate controlling an air conditioner of the vehicle, may indicate controlling a window, or may indicate controlling other facilities of the vehicle for example an audio system.

The diagnostic card 302 parses the received first control instruction to obtain a parsing result. The parsing result may indicate controlling the window, may indicate controlling a seat of the vehicle, may indicate controlling the air conditioner of the vehicle, or may indicate controlling other facilities of the vehicle.

The diagnostic card 302 controls to open or close the window of the vehicle according to the parsing result, in a case that the parsing result indicates controlling the window; the diagnostic card 302 adjusts at least one of a height and an angle of a seat of the vehicle according to the parsing result, in a case that the parsing result indicates controlling the seat; or the diagnostic card 302 adjusts at least one of a temperature, humidity, a wind speed and a wind direction of the air conditioner of the vehicle according to the parsing result, in a case that the parsing result indicates controlling the air conditioner. It should be noted that, the diagnostic card may be connected to the vehicle by using wired communication. For example, the diagnostic card is connected to an electronic control system of the vehicle, and controls the electronic control system of the vehicle by using the wired communication. The diagnostic card may also be connected to the vehicle by using wireless communication, for example a wireless communication mode such as WIFI or Bluetooth, and control the electronic control system of the vehicle by using the wireless communication.

The diagnostic card 302 transmits the parsing result to the mobile terminal 301.

The mobile terminal 301 stores the parsing result according to a category of the controlled object.

The mobile terminal 301 analyzes a habit of the user based on stored history parsing results to obtain a user habitual parameter, and stores the user habitual parameter. Taking the stored history controlled object being the air conditioner as an example. For example, a temperature of the air conditioner is 25 degree Celsius in a parsing result A, a temperature of the air conditioner is 24 degree Celsius in a parsing result B, and a temperature of the air conditioner is 25 degree Celsius in a parsing result C, hence, it is determined by analyzing that the user habitual parameter is the temperature of the air conditioner being 25 degree Celsius, and the user habitual parameter is stored. It is a conventional technique to analyze the habit of the user based on history data, which is not repeated here.

The mobile terminal 301 may transmit a second control instruction based on the stored user habitual parameter to the diagnostic card 302 when the vehicle is started, and the user habitual parameter may be included in the second control instruction.

The diagnostic card 302 parses the second control instruction to obtain a parsing result and controls the vehicle according to the parsing result.

In the embodiment, the mobile terminal 301 receives the vehicle control instruction sent by the user, establishes a wireless communication connection with the diagnostic card 302, and transmits the first control instruction to the diagnostic card 302 in response to the vehicle control instruction to request for controlling the vehicle. The diagnostic card 302 parses the received first control instruction to obtain the parsing result, and correspondingly controls the vehicle according to the parsing result; the diagnostic card 302 transmits the parsing result to the mobile terminal 301; the mobile terminal 301 stores the parsing result according to the category of the controlled object, analyzes the habit of the user based on the stored history parsing results to obtain the user habitual parameter, stores the user habitual parameter, and transmits the second control instruction based on the user habitual parameter to the diagnostic card 302; the diagnostic card 302 controls the vehicle according to the parsing result of the second control instruction, such that a passenger in a rear seat can control the vehicle by using the mobile terminal 301, and it is prevented that a driver is distracted to help the passenger in the rear seat in making an adjustment, thereby facilitating the passenger in the rear seat to control the vehicle. By analyzing the habit of the user, the mobile terminal 301 controls the vehicle when the vehicle is started, and controls the vehicle automatically based on the habit of the user, thereby improving user experience.

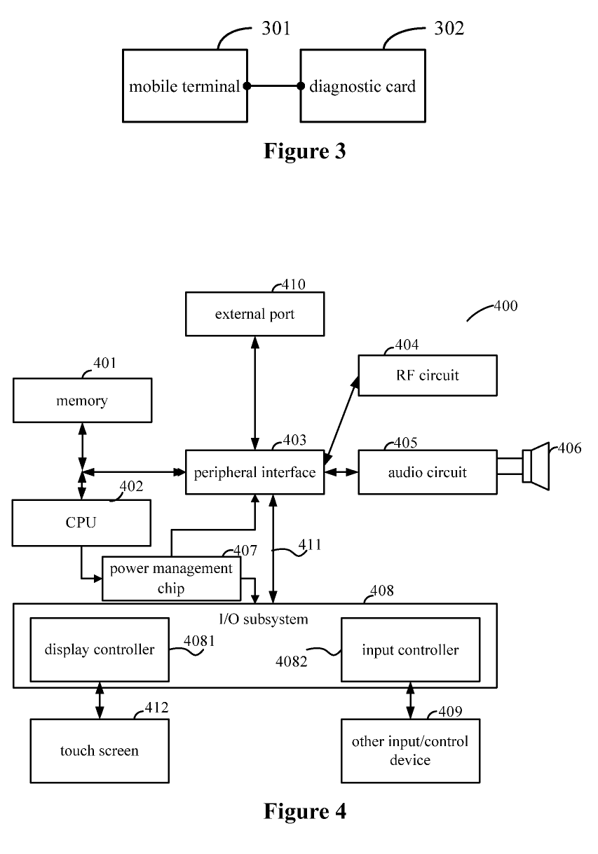

A mobile terminal is provided according to an embodiment of the present disclosure. Referring to FIG. 4, the mobile terminal is the mobile terminal in the embodiment as shown in FIG. 3.

It should be understood that, the mobile terminal 400 as shown in FIG. 4 is merely schematic. The mobile terminal 400 may include more or less components than the components as shown in FIG. 4, or may have a different component configuration, and in the mobile terminal 400 two or more components may be combined together. Various components as shown in FIG. 4 may be implemented in hardware, software including one or more signal processing and/or application-specific integrated circuit or a combination of the hardware and the software.

It is described according to an example of the mobile terminal 400. FIG. 4 is a schematic structural view of a mobile terminal for controlling a vehicle according to the present disclosure. As shown in FIG. 4, the mobile terminal 400 includes a memory 401, a central processing unit CPU 402, a peripheral interface 403, an RF circuit 404, an audio circuit 405, a speaker 406, a power management chip 407, an input/output (I/O) subsystem 408, other input/control device 409, and an external port 410, which communicate with each other via one or more communication buses or signal lines.

The mobile terminal 400 for controlling a vehicle according to the embodiment is described in detail hereinafter.

The memory 401: the memory 401 may be accessed by the CPU 402, the peripheral interface 403 or the like, and may include a high speed random access memory and a nonvolatile memory, such as one or more disk storage device, flash storage device or other volatile solid-state storage device.

The peripheral interface 403: the peripheral interface 403 may connect an input peripheral and an output peripheral of the device to the CPU 402 and the memory 401.

The I/O subsystem 408: the I/O subsystem 408 may connect the input peripheral and the output peripheral of the device, such as a touch screen 412 and the other input/control device 409, to the peripheral interface 403. The I/O subsystem 408 may include a display controller 4081 and one or more input controllers 4082 for controlling the other input/control device 409. The one or more input controller 4082 receives an electric signal from the other input/control device 409 or transmits an electric signal to the other input/control device 409. The other input/control device 409 may include a physical button (such as a press button and a rocker arm button), a dial pad, a slide switch, a joystick and a click roller. It should be noted that, the input controller 4082 may be connected to any one of: a keyboard, an infrared port, a USB interface and a pointing device such as a mouse.

The touch screen 412: the touch screen 412 is an input interface and an output interface between the mobile terminal 400 and a user, and displays visual output for the user. The visual output may include an image, a text, an icon or a video or the like.

The display controller 4081 of the I/O subsystem 408 receives an electric signal from the touch screen 412 or transmits an electric signal to the touch screen 412. The touch screen 412 detects touch on the touch screen 412, and the display controller 4081 converts the detected touch into an interaction with a user interface object displayed on the touch screen 412, that is, a human-machine interaction is achieved. The user interface object displayed on the touch screen 412 may be an icon for running a game, an icon for connecting to a corresponding network or the like. It should be noted that, the device may further include an optical mouse. The optical mouse is a touch-sensitive surface in which no visual output is displayed, or is an extension of the touch-sensitive surface formed by the touch screen.

The RF circuit 404 is mainly configured to establish communication between the mobile terminal 400 and a wireless network (i.e., a network side), thereby realizing data reception and transmission between the mobile terminal 400 and the wireless network, such as receiving and transmitting a short message, an E-mail and the like. The RF circuit 404 receives and transmits an RF signal, which is also referred to as an electromagnetic signal. The RF circuit 404 converts an electric signal into an electromagnetic signal or converts an electromagnetic signal into an electric signal, and communicates with a communication network and other devices by using the electromagnetic signal. The RF circuit 404 may include known circuits for performing the functions, which include but are not limited to an antenna system, an RF transceiver, one or more amplifier, a tuner, one or more oscillator, a digital signal processor, a CODEC chipset, or a subscriber identity module (SIM) or the like.

The audio circuit 405 is mainly configured to receive audio data from the peripheral interface 403, convert the audio data into an electric signal and transmit the electric signal to the speaker 406.

The speaker 406 is configured to restore a voice signal received from the wireless network by the mobile terminal using the RF circuit 404 into sound and play the sound for the user.

The power management chip 407 is configured to supply power for hardware which is connected to the CPU 402, the I/O subsystem 408 or the peripheral interface 403 and manage power.

In the embodiment, the RF circuit 404 establishes a wireless communication connection between the mobile terminal 400 with the diagnostic card by using Bluetooth, wireless fidelity WIFI or near field communication NFC.

The CPU 402 in the embodiment may be configured to receive a vehicle control instruction sent by the user, and transmit, in response to the vehicle control instruction, a first control instruction to the diagnostic card to request for controlling the vehicle.

In the embodiment, the CPU 402 stores a parsing result transmitted from the diagnostic card into the memory 401 according to a category of the controlled object.

In the embodiment, the CPU 402 analyzes a habit of the user according to history parsing results stored in the memory 401 to obtain a user habitual parameter, and stores the user habitual parameter in the memory 401. The CPU 402 transmits a second control instruction based on the user habitual parameter to the diagnostic card by using the RF circuit 404 when the vehicle is started, so that the diagnostic card controls the vehicle according to a parsing result of the second control instruction.

A mobile terminal of the system for controlling the vehicle is provided according to the embodiment, the mobile terminal receives the vehicle control instruction sent by the user and transmits the first control instruction to the diagnostic card in response to the vehicle control instruction to request for controlling the vehicle, such that a passenger in a rear seat can control the vehicle by using the mobile terminal. It is prevented that a driver is distracted to help the passenger in the rear seat in making an adjustment, and it facilitates the passenger in the rear seat to control the vehicle. By analyzing the habit of the user, the mobile terminal controls the vehicle when the vehicle is started, and controls the vehicle automatically based on the habit of the user, thereby improving user experience.

Those skilled in the art can clearly know that, for convenience and conciseness of the description, the operations of the systems, devices and units described above may be referred to the corresponding processes described in the preceding method embodiments, which is not repeated here.

A method and system for controlling a vehicle are described above, and the above embodiments are merely used to illustrate the technical solutions of the present disclosure rather than to limit the present disclosure. Although the present disclosure is described in detail with reference to the foregoing embodiments, those skilled in the art should understand that, modifications on the technical solutions described in the foregoing embodiments, or equivalent substitutions to a few of the technical features may still be made. However, such modifications or substitutions do not enable the essence of corresponding technical solutions to depart from the spirit and the scope of the technical solutions of the embodiments of the present disclosure.

1. A method for controlling a vehicle, comprising:
receiving, by a mobile terminal, a vehicle control instruction sent by a user;
transmitting, by the mobile terminal in response to the vehicle control instruction, a first control instruction to a diagnostic card to request for controlling the vehicle;
parsing, by the diagnostic card, the received first control instruction to obtain a parsing result; and
controlling, by the diagnostic card, the vehicle according to the parsing result.

2. The method according to claim 1, wherein before the transmitting, by the mobile terminal in response to the vehicle control instruction, a first control instruction to a diagnostic card to request for controlling the vehicle, the method further comprises:
establishing a wireless communication connection between the mobile terminal and the diagnostic card,
wherein the wireless communication connection comprises: a Bluetooth connection, a wireless fidelity WIFI connection, a near field communication NFC connection or an infrared connection.

3. The method according to claim 1 or 2, wherein the controlling, by the diagnostic card, the vehicle according to the parsing result comprises:
controlling, by the diagnostic card, to open or close a window of the vehicle in a case that the parsing result indicates controlling the window; and/or
adjusting, by the diagnostic card, at least one of a height and an angle of a seat of the vehicle in a case that the parsing result indicates controlling the seat; and/or
adjusting, by the diagnostic card, at least one of a temperature, humidity, a wind speed and a wind direction of an air conditioner of the vehicle in a case that the parsing result indicates controlling the air conditioner.

4. The method according to claim 1, wherein after the controlling, by the diagnostic card, the vehicle according to the parsing result, the method further comprises:
transmitting, by the diagnostic card, the parsing result to the mobile terminal; and
storing, by the mobile terminal, the parsing result according to a category of the controlled object.

5. The method according to claim 4, wherein after the storing, by the mobile terminal, the parsing result according to a category of the controlled object, the method further comprises:
analyzing, by the mobile terminal, a habit of the user based on stored history parsing results to obtain a user habitual parameter and storing, by the mobile terminal, the user habitual parameter; and
transmitting, by the mobile terminal, a second control instruction based on the user habitual parameter to the diagnostic card when the vehicle is started, wherein the diagnostic card controls the vehicle according to a parsing result of the second control instruction.

6. A system for controlling a vehicle, comprising:
a mobile terminal, and a diagnostic card connected to the vehicle; wherein
the mobile terminal is configured to receive a vehicle control instruction sent by a user, and transmit, in response to the vehicle control instruction, a first control instruction to the diagnostic card to request for controlling the vehicle; and
the diagnostic card is configured to parse the received first control instruction to obtain a parsing result and control the vehicle according to the parsing result.

7. The system according to claim 6, wherein the mobile terminal is further configured to establish a wireless communication connection with the diagnostic card by using Bluetooth, wireless fidelity WIFI, or near field communication NFC.

8. The system according to claim 6, wherein
the diagnostic card is further configured to control to open or close a window of the vehicle in a case that the parsing result indicates controlling the window; and/or
the diagnostic card is further configured to adjust at least one of a height and an angle of a seat of the vehicle in a case that the parsing result indicates controlling the seat; and/or
the diagnostic card is further configured to adjust at least one of a temperature, humidity, a wind speed and a wind direction of an air conditioner of the vehicle in a case that the parsing result indicates controlling the air conditioner.

9. The system according to claim 6, wherein the diagnostic card is further configured to transmit the parsing result to the mobile terminal; and
the mobile terminal is further configured to store the parsing result according to a category of the controlled object.

10. The system according to claim 9, wherein the mobile terminal is further configured to analyze a habit of the user based on stored history parsing results to obtain a user habitual parameter and store the user habitual parameter;
the mobile terminal is further configured to transmit a second control instruction based on the user habitual parameter to the diagnostic card when the vehicle is started; and
the diagnostic card is further configured to control the vehicle according to a parsing result of the second control instruction.

11. A mobile terminal, comprising:
a memory, a central processing unit, a peripheral interface, an RF circuit, a power management chip, an input/output subsystem, other input/control device, and an external port, which communicate with each other via one or more communication bus or signal line;
wherein the central processing unit is configured to receive a vehicle control instruction sent by a user, and transmit a first control instruction to a diagnostic card in response to the vehicle control instruction to request for controlling the vehicle, wherein the diagnostic card parses the received first control instruction to obtain a parsing result and controls the vehicle according to the parsing result.

12. The mobile terminal according to claim 11, wherein the RF circuit is configured to establish a wireless communication connection between the mobile terminal and the diagnostic card using Bluetooth, wireless fidelity WIFI, or near field communication NFC.

13. The mobile terminal according to claim 11, wherein the central processing unit is further configured to store the parsing result transmitted from the diagnostic card according to a category of the controlled object.

14. The mobile terminal according to claim 13, wherein the central processing unit is further configured to analyze a habit of the user according to history parsing results stored in the memory to obtain a user habitual parameter, and store the user habitual parameter in the memory; and
the central processing unit is further configured to transmit a second control instruction based on the user habitual parameter to the diagnostic card via the RF circuit when the vehicle is started, wherein the diagnostic card controls the vehicle according to a parsing result of the second control instruction.

15. The method according to claim 2, wherein the controlling, by the diagnostic card, the vehicle according to the parsing result comprises:
controlling, by the diagnostic card, to open or close a window of the vehicle in a case that the parsing result indicates controlling the window; and/or
adjusting, by the diagnostic card, at least one of a height and an angle of a seat of the vehicle in a case that the parsing result indicates controlling the seat; and/or
adjusting, by the diagnostic card, at least one of a temperature, humidity, a wind speed and a wind direction of an air conditioner of the vehicle in a case that the parsing result indicates controlling the air conditioner.

16. The system according to claim 7, wherein
the diagnostic card is further configured to control to open or close a window of the vehicle in a case that the parsing result indicates controlling the window; and/or
the diagnostic card is further configured to adjust at least one of a height and an angle of a seat of the vehicle in a case that the parsing result indicates controlling the seat; and/or
the diagnostic card is further configured to adjust at least one of a temperature, humidity, a wind speed and a wind direction of an air conditioner of the vehicle in a case that the parsing result indicates controlling the air conditioner.
